(19) United States
(12) Patent Application Publication
(10) Pub. No.: US 2008/0116605 A1
(43) Pub. Date: May 22, 2008

(54) Decorative structural building material

(76) Inventor: Robert M. Reiding, Tallahassee, FL (US)

Correspondence Address: J. WILEY HORTON, ESQUIRE;Pennington, Moore, Wilkinson, Bell & Dunbar, P.A., 215 S. Monroe St., 2nd Floor, Post Office Box 10095, Tallahassee, FL, 32301, US

(21) Appl. No.: 11/973,417

(22) Filed: Oct. 9, 2007

Related U.S. Application Data
(60) Provisional application No. 60/860,445, filed on Nov. 21, 2006.

(51) Int. Cl. B28B 5/00

(52) U.S. Cl. 264/241

(57) ABSTRACT

A casting having new and appealing decorative characteristics and a method for making the same. The casting of the present invention is made using a mixture of crushed and whole natural sea shells and coral, natural silica sand, cement, hydrated lime, and water. The mixture is poured into a mold and allowed to set. The casting is removed from the mold and the surface of the casting is treated with additional water to expose the shells and coral and/or coral rock. Once the casting is cured, the casting may be used as a decorative construction material.

### BACKGROUND OF THE INVENTION

1. Field of the Invention

This invention relates to the field of decorative structural building materials. More specifically, this invention comprises a casting having improved appearance and physical characteristics and a method for making the same.

2. Description of the Related Art

When constructing a new home or other building, it is often desirable to utilize structural building materials having decorative properties. This is particularly true for materials that form the exterior surfaces and other highly visible portions of the home or building. It has become increasingly common to produce structural building materials from molding processes. For example, molding processes are often used to produce concrete castings with surface characteristics that mimic the appearance of natural stone. Although many such materials are currently available, there remains a need for decorative structural materials having new appearances and physical characteristics.

### BRIEF SUMMARY OF THE INVENTION

The present invention is a casting having new and appealing decorative characteristics and a method for making the same. The casting of the present invention is made using a mixture of crushed and whole natural sea shells and coral and/or coral rock, natural silica sand, cement, hydrated lime, and water. The mixture is poured into a mold and allowed to set. The casting is removed from the mold and the surface of the casting is treated with additional water to expose the shells and coral and/or coral rock. Once the casting is cured, the casting may be used as a decorative construction material.

### BRIEF DESCRIPTION OF THE SEVERAL VIEWS OF THE DRAWINGS

FIG. 1 is a perspective view, illustrating a casting made using the method of the present invention.

FIG. 2 is a perspective view, illustrating a mixture being poured into a mold.

FIG. 3 is a perspective view, illustrating the mixture in the mold prior to surface treatment.

FIG. 4 is a perspective view, showing the mixture in the mold after the surface treatment.

### REFERENCE NUMERALS IN THE DRAWINGS

| | | | |
|---|---|---|---|
| 10 | casting | 12 | shells |
| 14 | coral | 16 | mixture |
| 18 | mold | 20 | mold cavity |
| 22 | exposed surface | 24 | scavenged sea objects |

### DETAILED DESCRIPTION OF THE INVENTION

The present invention is a casting having new and appealing decorative characteristics and a method for making the same. The casting of the present invention is made using a mixture of crushed and whole natural sea shells and coral and/or coral rock, natural silica sand, cement, hydrated lime, and water.

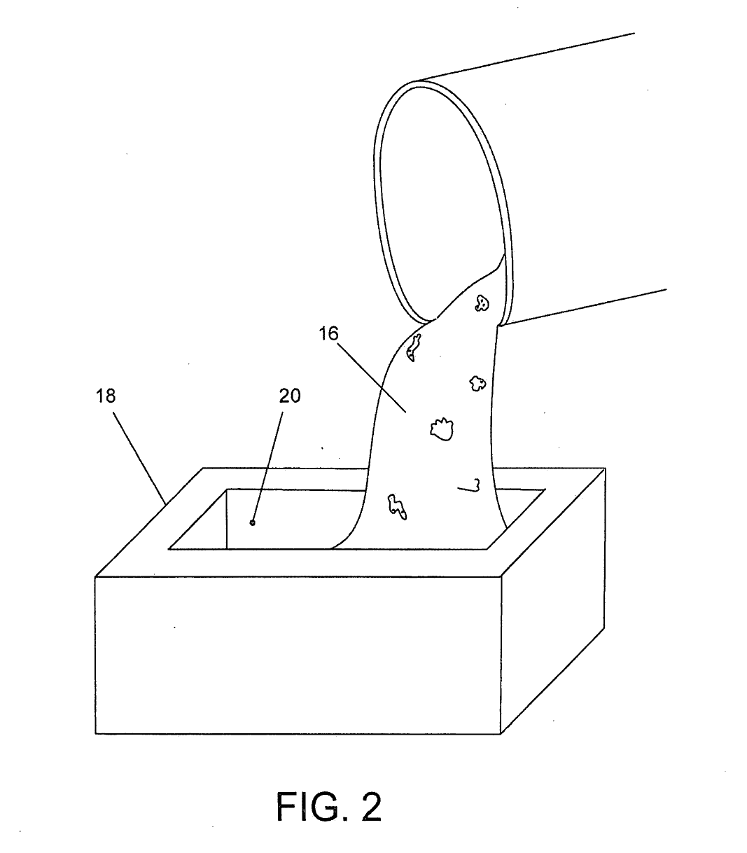

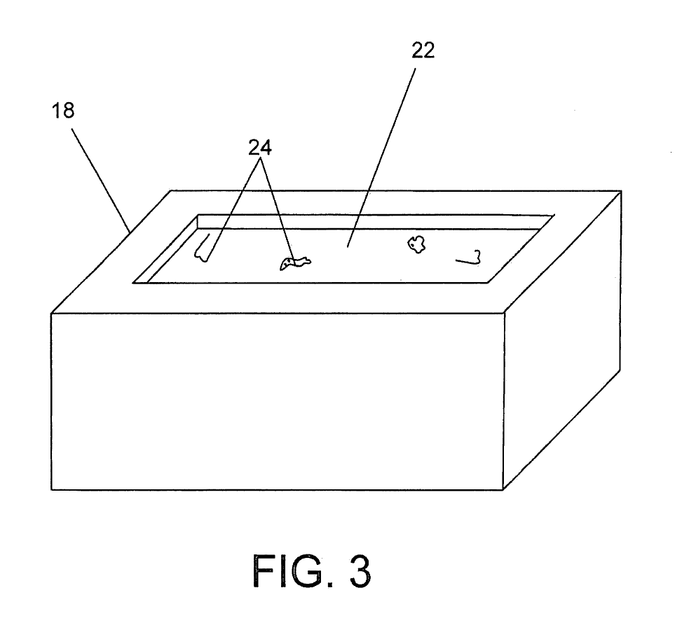

As shown in FIG. 2, mixture 16 is then poured into mold cavity 20 of mold 18. Mold 18 is preferably a break-down mold which can be disassembled for removing the casting. The casting is allowed to set for approximately 4 hours at approximately 80 degrees Fahrenheit. A casting which has been allowed to set for a period of time is shown in FIG. 3. Several exposed scavenged sea objects 24 are visible on surface 22.

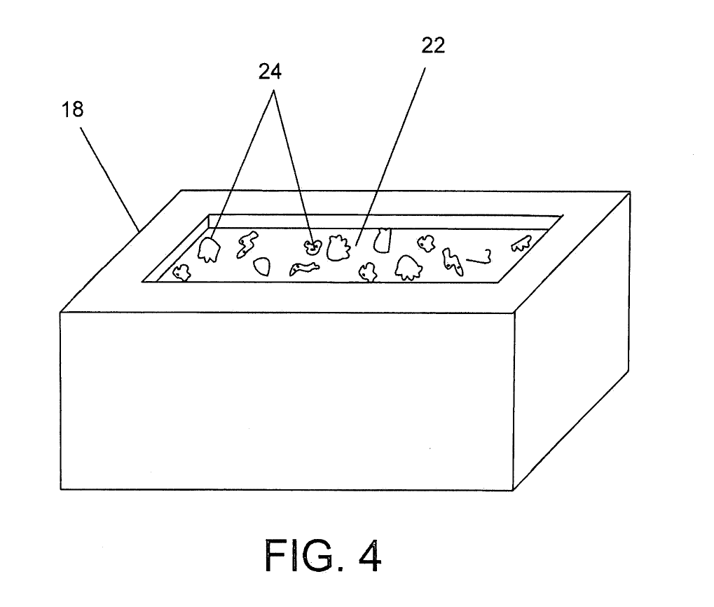

Once the casting has set, the casting is then removed from the mold and the surface of the casting is treated with additional water to expose the shells and coral and/or coral rock. There are many ways to perform the surface treatment. Generally, the objective of the surface treatment is to remove a layer of sand and cement that is covering the scavenged sea objects lying near the surface of the casting. There are many ways that water may be used to remove this layer. For example, water may be brushed or rolled over the surface with a brush or roller. Also, water may be sprayed against the surface of the casting with a water jet. It should be noted that surface 22 may also be treated while the casting is still situated in mold 18. As shown in FIG. 4, the treatment of surface 22 exposes scavenged sea objects 24 lying near surface 22.

Once the surface of the casting is treated with water the casting is allowed to cure. Many curing methods may be used for castings made using the previously described method. For example, the casting may be allowed to rest for 28 days in a moist environment. Alternatively, the casting may be cured more rapidly in a kiln. Once the casting is cured, the casting may be used as a decorative construction material. Several embodiments of the previous invention are described in greater detail subsequently.

### EXAMPLE ONE

In one embodiment, the present invention comprises a mixture of approximately 33 volume percent “scavenged” sea shells and coral and/or coral rock. The sea shells and coral and/or coral rock may be crushed or whole, but the pieces of shell and coral and/or coral rock preferably have an average maximum diameter of 0.75 inches. The mixture also includes natural silica sand at volume of approximately 22 percent, cement at approximately 17 percent of volume, hydrated lime at approximately 11 percent of volume, and water at approximately 17 percent of volume. The cement is preferably a white or grey Portland cement or combinations thereof. The actual percentage of the components may vary depending on the geographic region where the process is carried out and the water content of the “dry” ingredients.

Although the aforementioned percentages are preferred, a casting having substantially the same properties and characteristics of the present invention may be made by varying the composition of the mixture. For example, a mixture containing 25 to 50 percent shells and coral and/or coral rock, 6 to 40 percent natural silica sand, 10 to 32 percent cement, and 5 to 25 percent hydrated lime will have similar physical characteristics to a casting made in accordance with the preferred embodiment. Although the aforementioned ranges may be used to make an acceptable product, the preferred ranges for the mixture is 28 to 46 percent shells and coral and/or coral rock, 17 to 33 percent natural silica sand, 11 to 25 percent cement, and 5 to 20 percent hydrated lime. Cement may be a mixture of cement and Class F fly ash. In such a case, it is preferable that the mixture contain up to 40% by weight of Class F fly ash.

A mixture having such a composition is well mixed and poured into the cavity of a mold. The cavity of mold may be of any shape that is desired. For example, the mold cavity may be rectangular in shape so that a brick-type casting may be made. The mold may need to be shaken or vibrated to release air from the mixture. Once the mixture has been poured into the mold, the mixture is allowed to dry for approximately 4 hours at approximately 80 degrees Fahrenheit.

After the casting has been allowed to dry for approximately 4 hours (or before the casting has completely cured) the surface of the casting is treated with additional water. This water is used to remove a small layer of the sand, cement, and hydrated lime to expose larger portions of the shells and coral and/or coral rock. The casting is then allowed to cure.

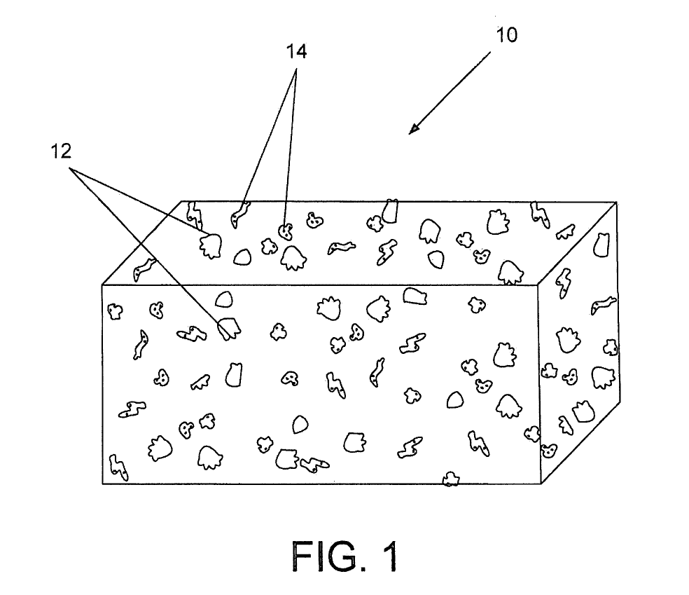

An example of a casting produced using the foregoing method is illustrated in FIG. 1. Casting 10 is prepared in a rectangular mold. The surfaces of casting 10 are then treated with water to expose shells 12 and coral 14 as previously described. The reader will note that only a small layer of sand, cement, and hydrated lime need to be removed to sufficiently expose shells 12 and coral 14.

### EXAMPLE TWO

The preferred embodiment may also be modified to produce a variant of the present invention that more closely mimics sandstone. This embodiment comprises a mixture of approximately 19 volume percent sea shells and coral and/or coral rock. The mixture also includes natural silica sand at volume of approximately 43 percent, cement at approximately 14 percent of volume, hydrated lime at approximately 10 percent of volume, and water at approximately 14 percent of volume. As mentioned previously with respect to tile preferred embodiment, the actual percentage of the components may vary depending on the geographic region where the process is carried out and the water content of the “dry” ingredients.

Although the aforementioned percentages are preferred, a casting having substantially the same properties and characteristics of the sandstone mimicking variant may be made by varying the composition of the mixture. For example, a mixture containing 5 to 30 percent shells and coral and/or coral rock, 30 to 50 percent natural silica sand, 10 to 28 percent cement, and 5 to 27 percent hydrated lime will have similar physical characteristics to a casting made in accordance with the preferred mixture. Although the aforementioned ranges may be used to make an acceptable product. the preferred ranges for the mixture is 15 to 30 percent shells and coral and/or coral rock, 35 to 48 percent natural silica sand, 10 to 22 percent cement, and 5 to 18 percent hydrated lime.

### EXAMPLE THREE

A variant of the present invention that more closely mimics limestone may also be produced. This embodiment comprises a mixture of approximately 17 volume percent sea shells and coral and/or coral rock. The mixture also includes natural silica sand at volume of approximately 9 percent, cement at approximately 13 percent of volume, hydrated lime at approximately 38 percent of volume, and water at approximately 23 percent of volume. As mentioned previously with respect to the preferred embodiment and the sandstone embodiment, the actual percentage of the components may vary depending on the geographic region where the process is carried out and the water content of the “dry” ingredients.

Although the aforementioned percentages are preferred, a casting having substantially the same properties and characteristics of the limestone mimicking variant may be made by varying the composition of the mixture. For example, a mixture containing 4 to 27 percent shells and coral and/or coral rock, 4 to 25 percent natural silica sand, 8 to 26 percent cement, and 25 to 44 percent hydrated lime will have similar physical characteristics to a casting made in accordance with the preferred mixture. Although the aforementioned ranges may be used to make an acceptable product. the preferred ranges for the mixture is 13 to 27 percent shells and coral and/or coral rock, 4 to 16 percent natural silica sand, 8 to 20 percent cement. and 32 to 44 percent hydrated lime.

Various mixtures of shells and coral and/or coral rock may be used in each of the foregoing examples. Unless stated otherwise, the reader should understate these percentages to represent volume percentages. Generally, the mixture of shells and coral and/or coral rock should consist of 30 to 90 percent shells (with the balance of the mixture constituting natural coral and/or coral rock). It is preferred, however, that the mixture contain mostly shells such that the mixture contains shells in a range of 50 to 90 percent. The most desirable mixture contains approximately 70 percent shells and 30 percent crushed natural coral and/or coral rock. Shells, coral, coral rock, and sand should be washed or rinsed with water before mixing to remove impurities and dried to control water content.

The preceding description contains significant detail regarding the novel aspects of the present invention. It should not be construed, however, as limiting the scope of the invention but rather as providing illustrations of the preferred embodiments of the invention. Thus, the scope of the invention should be fixed by the claims, rather than by the examples given.

What is claimed is:

1. A method of manufacturing a decorative structural building material comprising:
a. providing a mixture, said mixture including
i. cement;
ii. lime;
iii. sand;
iv. water; and
v. scavenged sea objects selected from a,group consisting of coral, coral rock, aid shells;
b. pouring said mixture into a mold cavity such that said mixture forms a casting with an exposed surface;
c. allowing said casting to set for a period of time;
d. applying water to said exposed surface to expose said scavenged sea objects near said exposed surface after said casting has set for said period of time; and
e. curing said casting.

2. The method of claim 1, wherein said scavenged sea objects constitute 5 to 50 percent of the total volume of said mixture.

3. The method of claim 2, wherein said scavenged sea objects constitute 25 to 50 percent of said total volume of said mixture.

4. The method of claim 1, wherein said sand constitutes 6 to 40 percent of the total volume of said mixture.

5. The method of claim 4, wherein said sand constitutes 17 to 33 percent of said total volume of said mixture.

6. The method of claim 5, wherein said sand is a natural silica sand.

7. The method of claim 6, wherein said scavenged sea objects constitute 25 to 50 percent of said total volume of said mixture.

8. The method of claim 1, wherein said cement constitutes 10 to 32 percent of the volume of said mixture.

9. The method of claim 7, wherein said cement constitutes 11 to 25 percent of said total volume of said mixture.

10. The method of claim 1, wherein said lime constitutes 5 to 25 percent of the total volume of said mixture.

11. The method of claim 9, wherein said lime constitutes 5 to 20 percent of said total volume of mixture.

12. The method of claim 1, wherein water is applied to said exposed surface with a brush.

13. The method of claim 1, wherein said casting is removed from said mold cavity before water is applied to said exposed surface.

14. The method of claim 1, wherein the step of applying water to said exposed surface to expose said scavenged sea objects near said exposed surface is accomplished by spraying said water against said exposed surface.

15. The method of claim 11, wherein water is applied to said exposed surface with a brush.

16. The method of claim 11, wherein said casting is removed from said mold cavity before water is applied to said exposed surface.

17. The method of claim 11, wherein the step of applying water to said exposed surface to expose said scavenged sea objects near said exposed surface is accomplished by spraying said water against said exposed surface.
